(19) United States
(12) Patent Application Publication
(10) Pub. No.: US 2022/0180380 A1
(43) Pub. Date: Jun. 9, 2022

(54) INFORMATION PROCESSING APPARATUS, INFORMATION PROCESSING METHOD, AND PROGRAM

(71) Applicant: FELICA NETWORKS, INC., TOKYO (JP)

(72) Inventor: JUN TADA, TOKYO (JP)

(21) Appl. No.: 17/439,332

(22) PCT Filed: Mar. 11, 2020
(86) PCT No.: PCT/JP2020/010597

§ 371 Date: Sep. 14, 2021

(30) Foreign Application Priority Data
Mar. 26, 2019 (JP) 2019-058163

(51) Int. Cl. G06Q 30/02; G06V 20/40; G06V 40/20

(52) U.S. Cl. CPC G06Q 30/0201; G06V 40/20; G06V 20/41

(57) ABSTRACT

An information processing apparatus according to the present technology includes a controller. The controller generates, on the basis of video data in which a purchasing behavior of a customer is imaged, customer action data regarding the purchasing behavior. The controller generates marketing data on the basis of the customer action data.

### TECHNICAL FIELD

The present technology relates to an information processing apparatus, an information processing method, and a program.

### BACKGROUND ART

Conventionally, manufacturers that manufacture and sell commodities perform marketing analyses primarily on two bases: commodity shipment data and retail sales data (POS data). Such marketing analyses have been sophisticated in analyzing the sales of commodities, etc., but have had difficulty in analyzing the backgrounds and psychological situations in which customers purchased commodities or did not purchase commodities.

In this regard, marketing methods considering not only the purchasing records of commodities but also the purchasing processes in which customers purchase commodities and customer attribute information have been recently proposed (for example, Patent Literature

### CITATION LIST

### Patent Literature

Patent Literature 1: Japanese Patent Application Laid-open No. 2003-067551

### DISCLOSURE OF INVENTION

### Technical Problem

As described above, there is a need for a marketing analysis considering a purchasing behavior or a psychological situation of a customer.

In view of the above circumstances, the present technology provides marketing data in which, for example, a purchasing behavior or the like of a customer is considered.

### Solution to Problem

In order to solve the above problems, an information processing apparatus according to an embodiment of the present technology includes a controller.

The controller generates, on the basis of video data in which a purchasing behavior of a customer is imaged, customer action data regarding the purchasing behavior.

The controller generates marketing data on the basis of the customer action data.

The controller may generate the marketing data on the basis of the customer action data and commodity data regarding a commodity.

The controller may generate the customer action data and customer data regarding the customer on the basis of the video data, and may generate the marketing data on the basis of the customer data, the customer action data, the commodity data, and sales method data for selling the commodity.

The controller may generate the marketing data on the basis of sales data of a store that sells the commodity.

The controller may generate the marketing data on the basis of environment data including information regarding an event, a temperature, or weather in a vicinity of the store.

The information processing apparatus may further include a server device that statistically processes the marketing data.

The server device may statistically process the marketing data with reference to the commodity data.

The server device may provide statistical data to a manufacturer who produces the commodity, the statistical data being obtained by statistically processing the marketing data with reference to the commodity data.

The server device may store store data regarding a store that sells the commodity, and statistically processes the marketing data with reference to the store data.

The server device may provide statistical data to the store that sells the commodity or a distribution destination that distributes the commodity, the statistical data being obtained by statistically processing the marketing data with reference to the store data.

In order to solve the above problems, an information processing method for an information processing apparatus according to an embodiment of the present technology includes: generating, on the basis of video data in which a purchasing behavior of a customer is imaged, customer action data regarding the purchasing behavior; and generating marketing data on the basis of the customer action data.

In the information processing method, the customer action data may be generated on the basis of the video data, and the marketing data may be generated on the basis of the customer action data and commodity data regarding a commodity.

In the information processing method, the customer action data and customer data regarding the customer may be generated on the basis of the video data, and the marketing data may be generated on the basis of the customer data, the customer action data, the commodity data, and sales method data for selling the commodity.

Further, in the information processing method, the marketing data may be statistically processed with reference to the commodity data, and the statistical data statistically processed may be provided to a manufacturer who produces the commodity.

Further, in the information processing method, the marketing data may be statistically processed with reference to store data regarding a store that sells the commodity, and the statistical data statistically processed may be provided to the store that sells the commodity or a distribution destination that distributes the commodity.

In order to solve the above problems, a program according to an embodiment of the present technology causes an information processing apparatus to execute the steps of: generating, on the basis of video data in which a purchasing behavior of a customer is imaged, customer action data regarding the purchasing behavior; and generating marketing data on the basis of the customer action data.

The program may cause the information processing apparatus to execute the steps of:

generating the customer action data on the basis of the video data; and generating the marketing data on the basis of the customer action data and commodity data regarding a commodity.

The program may cause the information processing apparatus to execute the steps of: generating the customer action data and customer data regarding the customer on the basis of the video data; and generating the marketing data on the basis of the customer data, the customer action data, the commodity data, and sales method data for selling the commodity.

The program may cause the information processing apparatus to further execute the steps of: statistically processing the marketing data with reference to the commodity data; and providing the statistical data statistically processed to a manufacturer who produces the commodity.

The program may cause the information processing apparatus to further execute the steps of: statistically processing the marketing data with reference to store data regarding a store that sells the commodity; and providing the statistical data statistically processed to the store that sells the commodity or a distribution destination that distributes the commodity.

### BRIEF DESCRIPTION OF DRAWINGS

FIG. 1 is a system diagram schematically showing a configuration example of an information processing system according to the present technology.

FIG. 2 is a block diagram showing a configuration example of a terminal device of the information processing system.

FIG. 3 is a block diagram showing a configuration example of a server device of the information processing system.

FIG. 4 is a block diagram showing a configuration example of a server device of the information processing system.

FIG. 5 is a block diagram showing a hardware configuration example of the terminal device or an information processing apparatus of the information processing system.

FIG. 6 is a sequence diagram showing an operation flow of the information processing system.

FIG. 7 is a sequence diagram showing an operation flow of the information processing system.

FIG. 8 is a sequence diagram showing an operation flow of the information processing system.

FIG. 9 is a conceptual diagram showing an example of providing statistical data, in which marketing data has been statistically processed, to a manufacturer.

FIG. 10 is a conceptual diagram showing an example of providing statistical data, in which marketing data has been statistically processed, to a retail store or distribution destination.

FIG. 11 is a diagram showing specific examples of various types of data.

FIG. 12 is a diagram showing an example of marketing data for a manufacturer.

FIG. 13 is a diagram showing specific examples of various types of data.

FIG. 14 is a diagram showing an example of marketing data for a retail store.

### MODE(S) FOR CARRYING OUT THE INVENTION

Hereinafter, an embodiment of the present technology will be described with reference to the drawings.

An information processing system according to the present technology is a network system capable of acquiring marketing data of any commodity mutually among a plurality of retail stores, an information processing apparatus, and a manufacturer or a distribution destination via a network such as the Internet.

Here, in the present technology, a retail store is a store that sells commodities purchased from producers or manufacturers of the commodities to final consumers. Examples of such stores include convenience stores and supermarkets.

The manufacturers are typically companies that produce commodities to be sold in retail stores. The distribution destinations are distributors who distribute commodities to be sold in retail stores and are also wholesalers who distribute commodities to the retail stores. Details of the information processing system of the present technology will be described below.

<Configuration of Information Processing System>

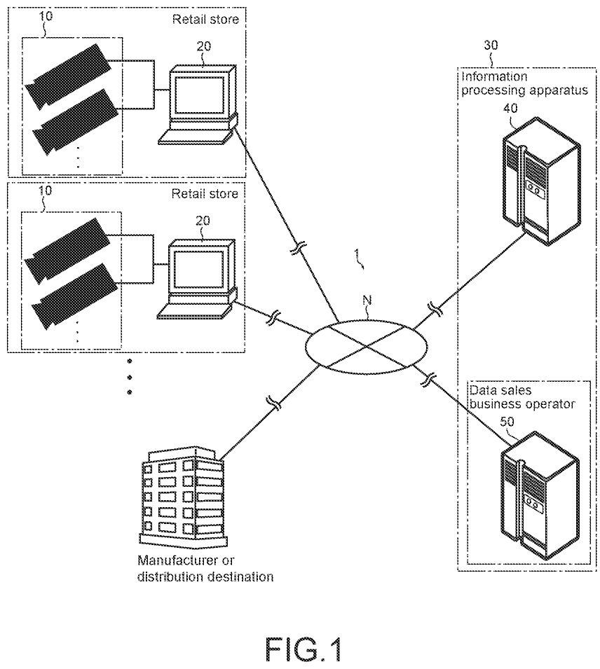

FIG. 1 is a system diagram schematically showing a configuration example of an information processing system 1 according to this embodiment. The information processing system 1 includes imaging units 10, a plurality of terminal devices 20, and an information processing apparatus 30 as shown in FIG. 1.

In this embodiment, the plurality of terminal devices 20, the information processing apparatus 30, and a manufacturer or a distribution destination are connected so as to be able to communicate with each other via a network N. The network N may be, for example, the Internet, a mobile communication network, a local area network, or the like, or may be a network in which a plurality of types of networks is combined.

[Imaging Unit]

The imaging unit 10 is installed in a retail store and connected to the terminal device 20 in a wired or wireless manner. The imaging unit 10 is a camera for forming an image of the inside of the retail store on an imaging device such as a charge coupled device (CCD) or a complementary metal oxide semiconductor (CMOS) through the lens to capture a still image or a moving image. The imaging unit 10 captures an image of a commodity, a behavior of a customer, or the like in the retail store.

[Terminal Device]

The terminal device 20 is a device that stores the video data captured by the imaging unit 10. The terminal device 20 is handled by the retail store. The terminal device 20 is typically a computer such as a desktop PC or a laptop PC, but is not limited thereto and may be, for example, a smart device or a tablet terminal.

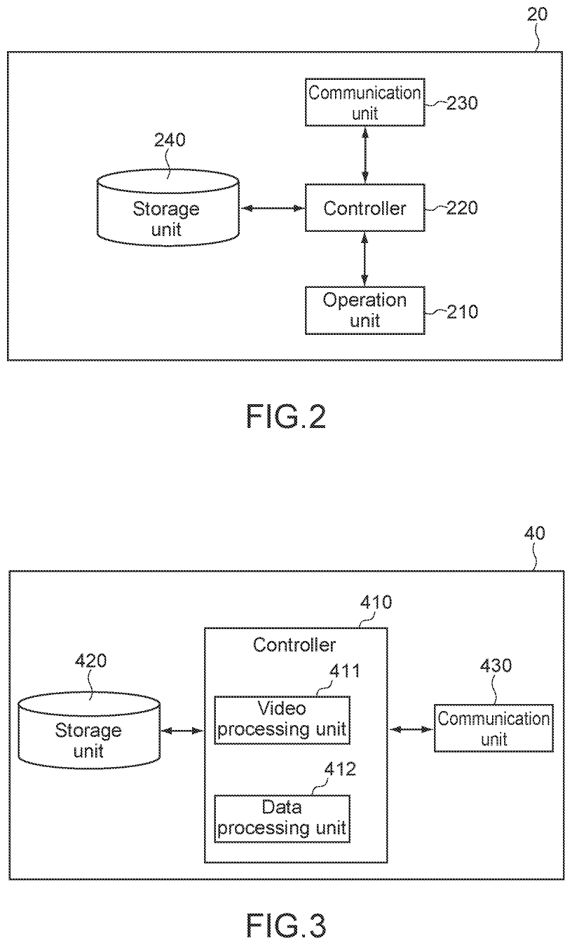

FIG. 2 is a block diagram showing a configuration example of the terminal device 20. As shown in FIG. 2, the terminal device 20 includes an operation unit 210, a controller 220, a communication unit 230, and a storage unit 240.

The operation unit 210 is a device operated by a user, such as a mouse, a keyboard, a touch panel, a button, a switch, or a lever, and is typically a keyboard and a mouse. In the terminal device 20, the operation of the terminal device 20 is controlled by the controller 220 according to the operation of the operation unit 210.

The controller 220 controls the overall operation of the terminal device 20 or part thereof. The communication unit 230 communicates with external devices such as the information processing apparatus 30 and the server device 40 via the network N. The communication unit 230 functions as a communication interface of the terminal device 20.

The storage unit 240 stores commodity data of commodities handled by the retail store, Point-Of-Sales (POS) data of the retail store, sales method data for selling commodities in the retail store, and environment data.

Here, the commodity data is, for example, data regarding at least one of a Japanese article number (JAN) code of the commodity, a commodity name, a manufacturer name, a commodity category, a package image, a raw material, a desired retail price of the manufacturer, or a sale date of the manufacturer.

The POS data is, for example, data at the time commodities are sold in the retail store, typically, the sales data of the retail store.

The sales method data is, for example, data regarding at least one of the presence/absence of sales of a commodity in the retail store (whether or not a specific commodity is on sale), a sales start date, a sales price, an arrangement category, a display position, a distance from the main entrance, the number of shelves occupied (number of faces), the presence/absence of a pop, or the presence/absence of a discount campaign.

The environment data is, for example, data including information regarding events, a temperature, or weather in the vicinity of the retail store or the specifications of the imaging unit 10.

Note that the terminal device 20 may be omitted as necessary in this embodiment. In this case, the imaging unit 10 may have the above-mentioned configuration including the operation unit 210, the controller 220, the communication unit 230, and the storage unit 240.

[Information Processing Apparatus]

The information processing apparatus 30 includes server devices 40 and 50. The server device 40 is a server for constructing data to be statistically processed by the server device 50 on the basis of the information acquired from the terminal device 20 via the network N. The server devices 40 and 50 of this embodiment are typically web servers, but are not limited thereto. For examples, any other computer such as a PC may be used.

FIG. 3 is a block diagram showing a configuration example of the server device 40. As shown in FIG. 3, the server device 40 includes a controller 410, a storage unit 420, and a communication unit 430.

The controller 410 controls the overall operation of the server device 40 or part thereof according to a program stored in the storage unit 420. The controller 410 functionally includes a video processing unit 411 and a data processing unit 412. The controller 410 is an example of a “controller” in Claims.

The video processing unit 411 performs predetermined video processing on the video data in which the inside of the retail store is imaged by the imaging unit 10. In such a manner, customer data and customer action data based on the video data are generated, and those pieces of data are output to the data processing unit 412 and the storage unit 420.

Here, the customer data is, for example, data regarding at least one piece of information regarding sex, age, the number of people, clothes, or the baggage of the customers in the retail store.

In addition, the customer action data is, for example, data regarding at least one piece of: whether or not a customer in the retail store has passed in front of the commodity, how long the customer has stayed in front of the commodity, whether or not the customer has recognized the commodity, how long the customer has viewed the commodity, whether or not the customer has picked up the commodity, whether or not the customer has returned the commodity to the place where the commodity was, whether or not the customer has put the commodity in the basket, how long it has taken for the customer to do the next action after picking up the commodity, whether or not the customer has purchased the commodity, comparison between the action for a specific commodity and the actions for commodities adjacently arranged all around the specific commodity, a time period elapsed after the entrance to the retail store, a time period from the entrance to the exit from the retail store, whether or not the customer has talked with a customer's accompanying person in the retail store at the time of purchase of the commodity, the total stay time since the customer entered the retail store, the total number of walking steps from the entrance to the retail store, the walking speed when the customer walked in the retail store, the number of commodities purchased, a time at which the customer entered the retail store (season, time zone, etc.), or a day of the week on which the customer entered the retail store.

The data processing unit 412 constructs data on the basis of the customer data and the customer action data, which are acquired from the video processing unit 411, the commodity data and the sales method data acquired from the terminal device 20, and the like. The data processing unit 412 outputs such data to the server device 50 and the storage unit 420.

The storage unit 420 stores the commodity data and the sales method data acquired from the terminal device 20, the data subjected to video processing by the video processing unit 411, and marketing data generated on the basis of the customer data, the customer action data, the commodity data, the sales method data, and the like. Further, the storage unit 420 stores a store identification ID for identifying each of a plurality of retail stores.

The communication unit 430 communicates with external devices such as the terminal device 20 and the server device 50 via the network N. The communication unit 430 functions as a communication interface of the server device 40.

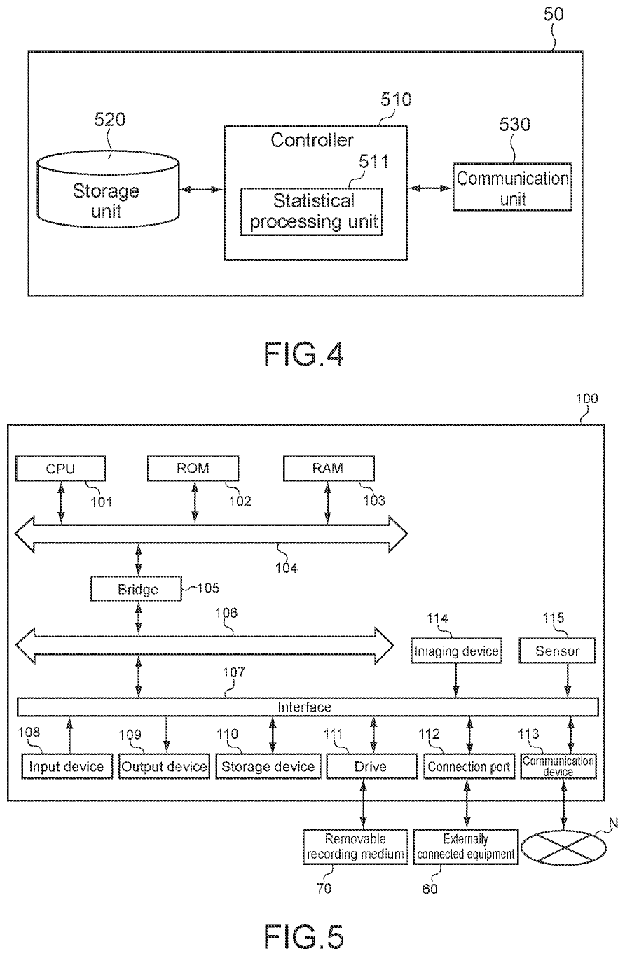

FIG. 4 is a block diagram showing a configuration example of the server device 50. As shown in FIG. 4, the server device 50 includes a controller 510, a storage unit 520, and a communication unit 530.

The controller 510 controls the overall operation of the server device 50 or part thereof according to a program stored in the storage unit 520. The controller 510 functionally includes a statistical processing unit 511.

The statistical processing unit 511 performs statistical processing on the marketing data generated on the basis of the customer data, the customer action data, the commodity data, the sales method data, and the like, which is acquired from the server device 40, and outputs the statistical data after the statistical processing to a manufacturer, a distribution destination, and the storage unit 520.

The storage unit 520 stores store data for each of a plurality of retail stores, marketing data, and statistical data obtained by performing statistical processing on the marketing data by the statistical processing unit 511.

Here, the store data is, for example, data regarding at least one of a business condition, a store size, the address, the distance to a station, a population of a commercial area, or the number of parking lots of the retail store.

The communication unit 530 communicates with external devices such as the terminal device 20 and the server device 40 via the network N. The communication unit 530 functions as a communication interface of the server device 50.

As shown in FIG. 1, the server device 50 is handled by a data sales business operator. The data sales business operator is a business operator who statistically processes the marketing data acquired from the server device 40, and sells and provides statistical data having been subjected to statistical processing to a manufacturer or a distribution destination.

[Hardware Configuration]

FIG. 5 is a block diagram showing an example of a hardware configuration of the terminal device 20 and the information processing apparatus 30. The terminal device 20, the server device 40, or the server device 50 may be achieved by an information processing apparatus 100 shown in FIG. 5.

The information processing apparatus 100 includes a central processing unit (CPU) 101, a read only memory (ROM) 102, and a random access memory (RAM) 103.

Further, the information processing apparatus 100 may include a host bus 104, a bridge 105, an external bus 106, an interface 107, an input device 108, an output device 109, a storage device 110, a drive 111, a connection port 112, and a communication device 113.

Furthermore, the information processing apparatus 100 may include an imaging device 114 and a sensor 115 as necessary. The information processing apparatus 100 may include a processing circuit such as a digital signal processor (DSP), an application specific integrated circuit (ASIC), or a field-programmable gate array (FPGA) instead of or together with the CPU 101.

The CPU 101 functions as an arithmetic processing unit and a controller, and controls the overall operation of the information processing apparatus 100 or part thereof according to various programs recorded in the ROM 102, the RAM 103, the storage device 110, or on a removable recording medium 70. The controllers 220, 410, and 510 may be the CPU 101.

The ROM 102 stores programs and arithmetic parameters to be used by the CPU 101. The RAM 103 temporarily stores programs to be used in the execution of the CPU 101, parameters that appropriately change in the execution of the program, and the like.

The CPU 101, the ROM 102, and the RAM 103 are interconnected by a host bus 104 including an internal bus such as a CPU bus. In addition, the host bus 104 is connected via a bridge 105 to an external bus 106 such as a peripheral component interconnect/interface (PCI) bus. The storage units 240, 420, and 520 may be the ROM 102, the RAM 103, the storage device 110, or the removable recording medium 70.

The input device 108 is a device operated by a user, such as a mouse, a keyboard, a touch panel, a button, a switch, or a lever. The input device 108 may be, for example, a remote control device using infrared rays or other radio waves, or may be externally connected equipment 60 such as a mobile phone corresponding to the operation of the information processing apparatus 100.

The input device 108 includes input control circuits for generating input signals on the basis of information input by the user and outputting the generated input signals to the CPU 101. By operating the input device 108, the user inputs various types of data to the information processing apparatus 100 or instructs processing operations. The operation unit 210 may be the input device 108.

The output device 109 is configured by a device capable of notifying the user of the acquired information by using senses such as a sense of vision, a sense of hearing, and a sense of touch. The output device 109 may be, for example, a display device such as a liquid crystal display (LCD) or an organic electro-luminescence (EL) display, a sound output device such as a speaker or headphones, or a vibrator. The output device 109 outputs the result acquired by the processing of the information processing apparatus 100 as a video such as a text or an image, a sound such as voice or audio, or vibration.

The storage device 110 is a data storage device configured as an example of a storage unit of the information processing apparatus 100. The storage device 110 is configured by, for example, a magnetic storage device such as a hard disk drive (HDD), a semiconductor storage device, an optical storage device, or a magneto-optical storage device. The storage device 110 stores, for example, programs to be executed by the CPU 101, various types of data, and various types of data acquired from the outside.

The drive 111 is a reader/writer for the removable recording medium 70 such as a magnetic disk, an optical disc, a magneto-optical disk, or a semiconductor memory, and is built in or externally attached to the information processing apparatus 100. The drive 111 reads the information recorded on the removable recording medium 70 mounted thereon, and outputs the read information to the RAM 103. Further, the drive 111 writes a record on the removable recording medium 70 mounted thereon.

The connection port 112 is a port for connecting a device to the information processing apparatus 100. The connection port 112 may be, for example, a universal serial bus (USB) port, an IEEE1394 port, or a small computer system interface (SCSI) port. Further, the connection port 923 may be an RS-232C port, an optical audio terminal, a high-definition multimedia interface (HDMI) (registered trademark) port, or the like. The externally connected equipment 60 is connected to the connection port 112, and thus various types of data can be exchanged between the information processing apparatus 100 and the externally connected equipment 60.

The communication device 113 is, for example, a communication interface including a communication device for connecting to the network N, or the like. The communication device 113 may be, for example, a communication card for a local area network (LAN), Bluetooth (registered trademark), Wi-Fi, or wireless USB (WUSB).

Further, the communication device 113 may be a router for optical communication, a router for asymmetric digital subscriber line (ADSL), or modems for various types of communication. The communication device 113 transmits and receives signals and the like to and from the Internet or other communication devices by using a predetermined protocol such as TCP/IP.

Furthermore, the network N connected to the communication device 113 is a network connected in a wired or wireless manner and may include, for example, the Internet, a home LAN, infrared communication, radio wave communication, and satellite communication. The communication units 230, 430, and 530 may be the communication device 113.

The imaging device 114 is, for example, a device that images a real space and generates a captured image by using various members including an imaging device such as a complementary metal oxide semiconductor (CMOS) or a charge coupled device (CCD), a lens for controlling the formation of an object image on the imaging device, and the like. The imaging device 114 may capture a still image or may capture a moving image.

The sensor 115 is, for example, various sensors such as an acceleration sensor, an angular velocity sensor, a geomagnetic sensor, an illuminance sensor, a temperature sensor, an air pressure sensor, and a sound sensor (microphone).

The sensor 115 acquires, for example, information regarding the state of the information processing apparatus 100 itself such as the posture of the housing of the information processing apparatus 100, and information regarding the peripheral environment of the information processing apparatus 100 such as the brightness and noise around the information processing apparatus 100.

The sensor 115 may also include a GPS receiver that receives a global positioning system (GPS) signal to measure the latitude, longitude, and altitude of the apparatus.

An example of the configuration of the terminal device 20 and the information processing apparatus 30 has been described above. Each of the above-mentioned components may be configured by using a general-purpose member or may be configured by a member specialized for the function of each component. Such a configuration may be changed as appropriate according to the technical level at the time of implementation.

<Operation of Information Processing System>

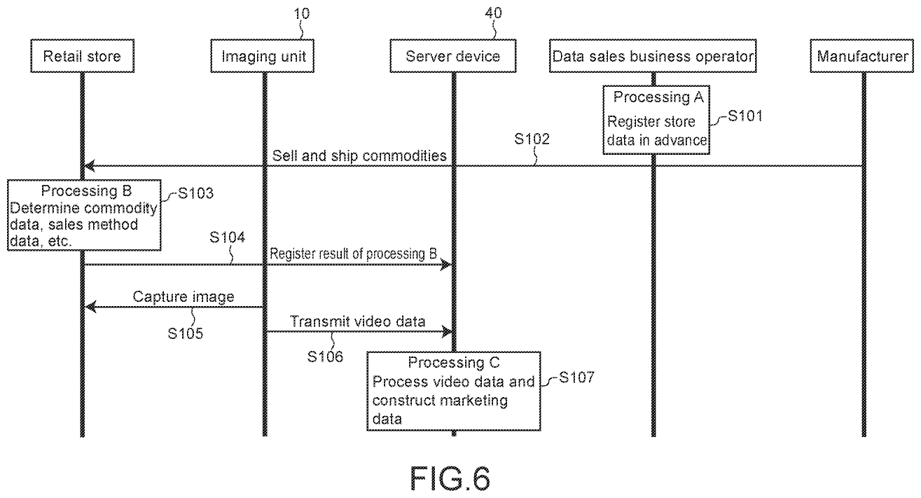

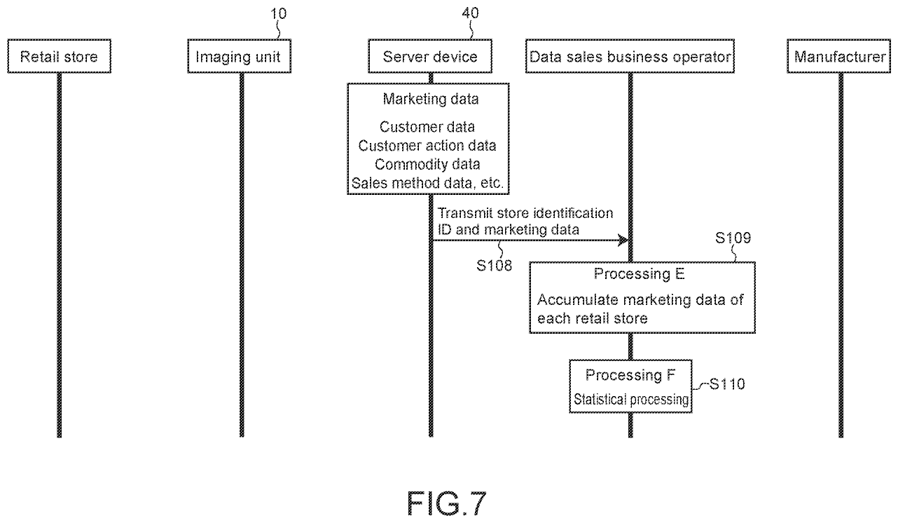

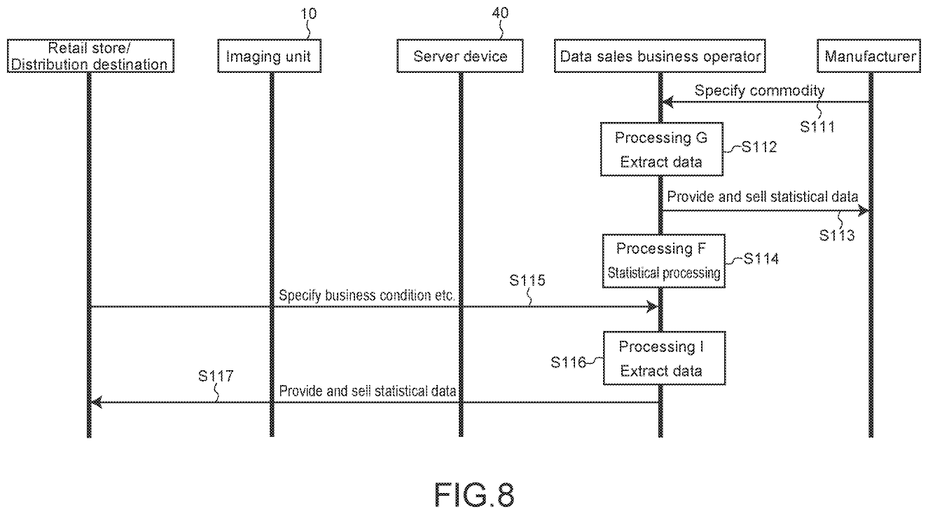

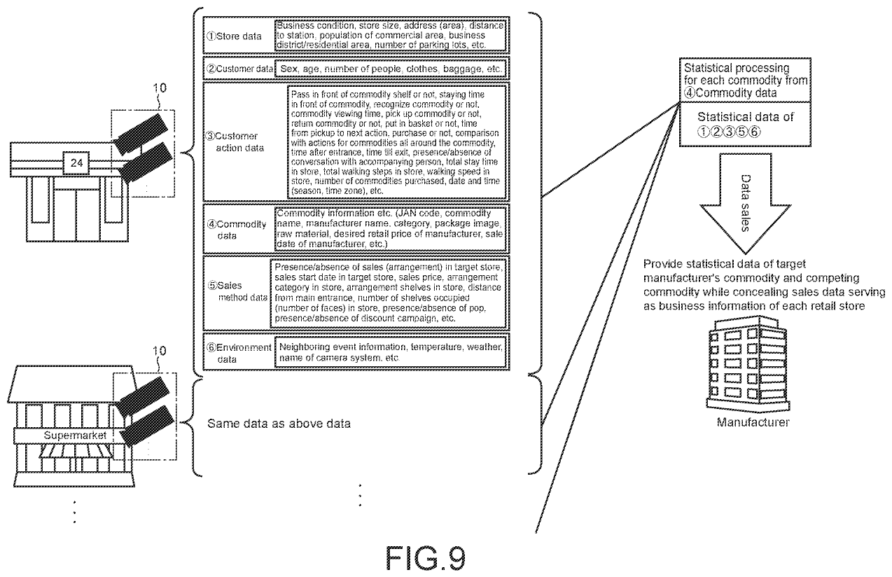

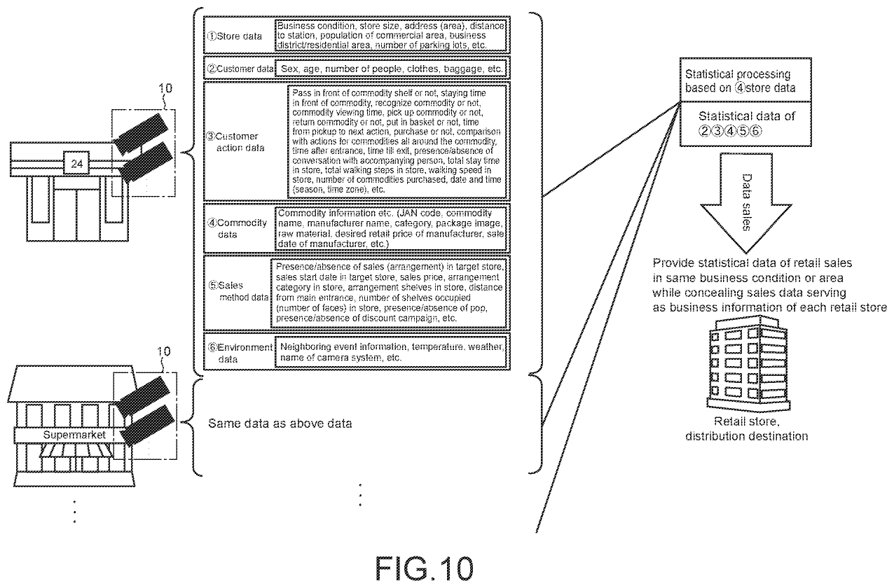

FIGS. 6 to 8 are sequence diagrams showing a typical operation flow of the information processing system 1. Further, FIG. 9 is a conceptual diagram showing an example of providing statistical data obtained by statistically processing the marketing data to a manufacturer, and FIG. 10 is a conceptual diagram showing an example of providing statistical data obtained by statistically processing the marketing data to a retail store or a distribution destination. Hereinafter, the operation of the information processing system 1 will be described with reference to FIGS. 6 to 10 as appropriate.

First, the data sales business operator registers store data (Step S101). As a result, the store data of the retail store is stored in the storage unit 520 of the server device 50. The manufacturer then sells and ships its own commodities to the retail store (Step S102).

Next, the retail store selects, from the data stored in the storage unit 240, the commodity data, the sales method data, the POS data, and the environment data regarding the commodities purchased from the manufacturer (Step S103), and outputs those pieces of data to the server device 40 via the terminal device 20 (Step S104). Thus, the commodity data, the sales method data, the POS data, and the environment data are stored in the storage unit 420 of the server device 40.

Subsequently, the imaging unit 10 images the purchasing behaviors of customers in the retail store (Step S105). The imaging unit 10 outputs the video data obtained by imaging the purchasing behaviors of customers to the server device 40 (video processing unit 411) (Step S106). The video processing unit 411 performs predetermined video processing on the video data obtained from the imaging unit 10, and generates customer data and customer action data. The video processing unit 411 outputs the customer data and the customer action data to the data processing unit 412.

The data processing unit 412 reads the commodity data, the sales method data, the POS data, and the environment data stored in the storage unit 420, and generates the marketing data on the basis of those pieces of data and the customer data and the customer action data acquired from the video processing unit 411 (Step S107). Note that the POS data and the environment data may be omitted as necessary in Step S107.

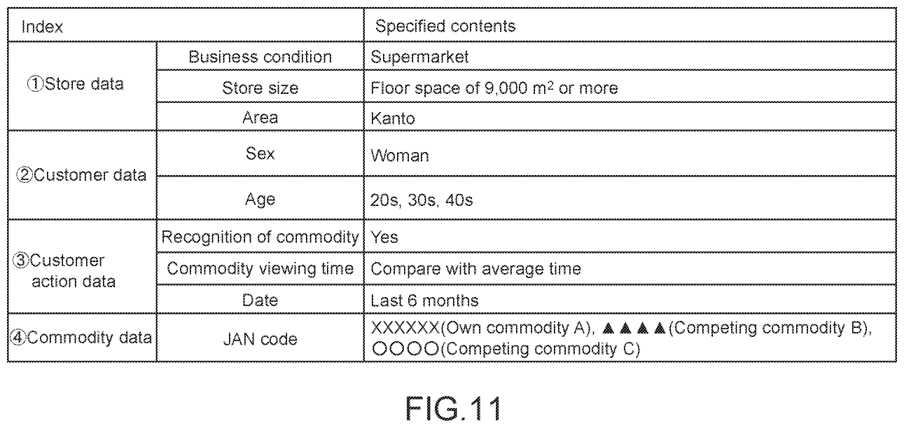

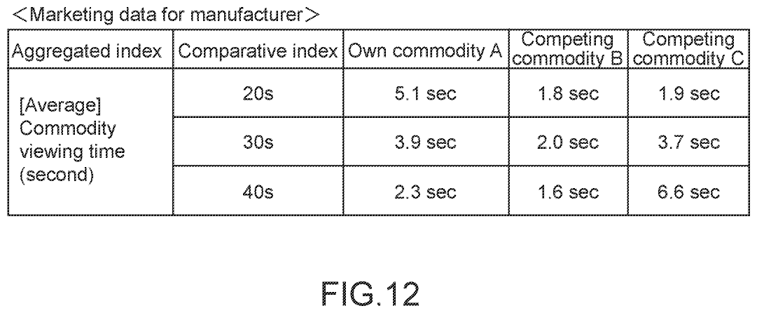

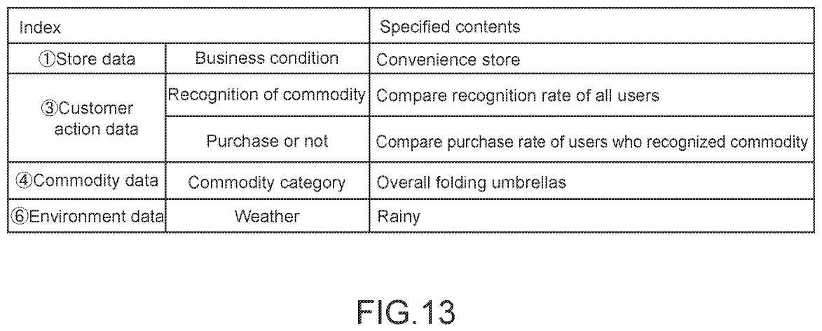

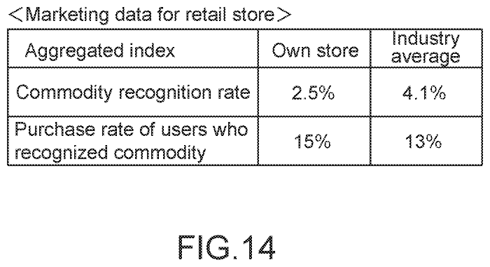

FIGS. 11 and 13 are diagrams showing specific examples of various pieces of data, and FIGS. 12 and 14 are diagrams showing examples of the marketing data. Specifically, when the store data, the customer data, the customer action data, and the commodity data are data as shown in FIG. 11, the data processing unit 412 generates marketing data for a manufacturer as shown in FIG. 12, for example.

This allows the manufacturer to grasp the trend of each commodity. For example, referring to FIG. 12, the commodity viewing time for a manufacturer's own commodity A becomes longer as the age is younger, and the commodity viewing time for a competing commodity B becomes shorter regardless of the age. Furthermore, the commodity viewing time for a competing commodity C becomes longer as the age is older, and such a trend of each commodity can be found.

Alternatively, when the store data, the customer action data, the commodity data, and the environment data are data as shown in FIG. 13, the data processing unit 412 generates marketing data for a retail store as shown in FIG. 14, for example.

This allows the retail store to perform a sales analysis based on the marketing data. For example, referring to FIG. 14, when folding umbrellas are recognized by users on a rainy day, the purchasing rate of the own store is almost the same as that of the industry average, but the users do not recognize the folding umbrellas of the own store as compared with the industry average. Therefore, it is understood that the location where the folding umbrellas are placed is bad and that the appealing effect of the vinyl umbrellas to the users is low in the own store.

Subsequently, the data processing unit 412 reads the store identification ID stored in the storage unit 420, and associates the store identification ID with the marketing data. The data processing unit 412 outputs data in which the marketing data and the store identification ID are associated with each other to the data sales business operator (server device 50) (Step S108).

In this embodiment, the above Steps S101 to S108 are performed for each of a plurality of retail stores. As a result, the storage unit 520 of the server device 50 stores the data in which the marketing data and the store identification ID are associated with each other for each retail store (Step S109).

Subsequently, the server device 50 (statistical processing unit 511) performs statistical processing on the marketing data (for example, see FIG. 12) for each of the plurality of retail stores with reference to the commodity data (Step S110), and outputs the statistical data having been subjected to the statistical processing to the storage unit 520. The storage unit 520 stores, for example, statistical data in which the marketing data has been statistically processed for each commodity. As a result, sales information in a specific retail store is concealed.

The method of statistically processing the marketing data in the statistical processing unit 511 is not particularly limited, and the type thereof such as a regression analysis, a cluster analysis, a gray model, a conjoint analysis, a nearest neighbor method, an experimental design method, a principal component analysis, a numerical theory I, a numerical theory II, dual scaling, a discriminant analysis, the Mahalanobis distance (MTS), or combinations thereof is not limited.

Next, the manufacturer outputs an acquisition request for acquiring statistical data obtained by statistically processing its own commodities or competing commodities to the data sales business operator (server device 50) (Step S111). In response to the acquisition of the acquisition request from the manufacturer, the server device 50 reads, from the storage unit 520, the statistical data obtained by statistically processing the marketing data in accordance with a commodity standard desired by the manufacturer (Step S112). The data sales business operator provides the statistical data to the manufacturer and sells the statistical data (Step S113, see FIG. 9).

This provides the statistical data to the manufacturer without revealing sales data, which is confidential information of the retail store. In particular, when acquiring the statistical data obtained by statistically processing the marketing data in accordance with the commodity standard desired by the manufacturer, the manufacturer can quantitatively grasp a customer insight (insight into the psychic thinking of the customer), which is not known only from the sales data, e.g., on which shelf the manufacturer's own commodities or the competing commodities are provided, the time during which a commodity is seen by customers, the time during which a commodity is held by customers, and the like.

In addition, the manufacturer can analyze the above statistical data on the basis of, for example, the business condition of the retail store, the store size, and the area, and further the time zone, season, day of the week, and weather in which customers have taken specific actions, to grasp what purchasing behaviors the customers have taken for the manufacturer's own commodities or competing commodities in response to each situation.

Next, the server device 50 (statistical processing unit 511) performs statistical processing on the marketing data (for example, see FIG. 14) for each of the plurality of retail stores with reference to the store data read from the storage unit 520 (Step S114), and outputs the statistical data having been subjected to the statistical processing to the storage unit 520. As a result, the individual store names and chain names of the retail store are concealed with respect to competing retail stores in the same business condition and the same area.

Subsequently, the retail store or the distribution destination outputs, to the data sales business operator (server device 50), an acquisition request for acquiring statistical data obtained by statistically processing the marketing data on the basis of the business condition, area, and the like of the retail store (Step S115). In response to the acquisition of the acquisition request from the retail store or the distribution destination, the server device 50 reads from the storage unit 420 the statistical data obtained by statistically processing the marketing data in accordance with the desired standard of the retail store or the distribution destination (Step S116). The data sales business operator provides and sells the statistical data to the retail store or the distribution destination (Step S117, see FIG. 10).

<Modifications>

Although the embodiment of the present technology has been described above, the present technology is not limited to the embodiment described above, and of course various modifications may be made thereto.

For example, in the above embodiment, the server device 40 acquires the POS data and the environment data in Step S104, but the present technology is not limited thereto. The POS data and the environment data may be acquired by the server device 40 in Step S106, Step S107, Step S110, or Step S114, for example.

Further, in the operation of the information processing system 1 according to the above embodiment, Steps S102, S104, S111, and S115 may be omitted as necessary. Further, unattended settlement processing using the marketing data may be performed between Step S107 and Step S108.

<Supplement>

The embodiment of the present technology may include, for example, an information processing apparatus as described above, an information processing system, an operation executed by the information processing apparatus or the information processing system, a program for causing the information processing apparatus to function, and a non-transitory, tangible medium on which the program is recorded.

Further, although the information processing system 1 of this embodiment has been described on the assumption that the statistical data is provided to a retail store, a manufacturer, or a distribution destination, the present technology is not limited thereto. The application of the present technology is not particularly limited.

In addition, the effects described herein are illustrative or exemplary only and not restrictive. In other words, the present technology may provide other effects apparent to those skilled in the art from the description herein, in addition to or instead of the effects described above.

Although the suitable embodiment of the present technology has been described in detail above with reference to the accompanying drawings, the present technology is not limited to such an example. It is clear that persons who have common knowledge in the technical field of the present technology could conceive various alterations or modifications within the scope of the technical idea described in the Claims. It is understood that of course such alterations or modifications also fall under the technical scope of the present technology.

Note that the present technology can have the following configurations.

(1) An information processing apparatus, including

a controller that

generates, on the basis of video data in which a purchasing behavior of a customer is imaged, customer action data regarding the purchasing behavior, and

generates marketing data on the basis of the customer action data.

(2) The information processing apparatus according to (1), in which

the controller generates the marketing data on the basis of the customer action data and commodity data regarding a commodity.

(3) The information processing apparatus according to (2), in which

the controller

generates the customer action data and customer data regarding the customer on the basis of the video data, and

generates the marketing data on the basis of the customer data, the customer action data, the commodity data, and sales method data for selling the commodity.

(4) The information processing apparatus according to (2) or (3), in which

the controller generates the marketing data on the basis of sales data of a store that sells the commodity.

(5) The information processing apparatus according to (4), in which

the controller generates the marketing data on the basis of environment data including information regarding an event, a temperature, or weather in a vicinity of the store.

(6) The information processing apparatus according to any one of (2) to (5), further including

a server device that statistically processes the marketing data.

(7) The information processing apparatus according to (6), in which

the server device statistically processes the marketing data with reference to the commodity data.

(8) The information processing apparatus according to (6) or (7), in which

the server device provides statistical data to a manufacturer who produces the commodity, the statistical data being obtained by statistically processing the marketing data with reference to the commodity data.

(9) The information processing apparatus according to any one of (6) to (8), in which

the server device stores store data regarding a store that sells the commodity, and statistically processes the marketing data with reference to the store data.

(10) The information processing apparatus according to (9), in which

the server device provides statistical data to the store that sells the commodity or a distribution destination that distributes the commodity, the statistical data being obtained by statistically processing the marketing data with reference to the store data.

(11) An information processing method, including:

by an information processing apparatus,

generating, on the basis of video data in which a purchasing behavior of a customer is imaged, customer action data regarding the purchasing behavior; and

generating marketing data on the basis of the customer action data.

(12) The information processing method according to (11), in which

the customer action data is generated on the basis of the video data, and

the marketing data is generated on the basis of the customer action data and commodity data regarding a commodity.

(13) The information processing method according to (12), in which

the customer action data and customer data regarding the customer are generated on the basis of the video data, and

the marketing data is generated on the basis of the customer data, the customer action data, the commodity data, and sales method data for selling the commodity.

(14) The information processing method according to (12) or (13), in which

the information processing apparatus further statistically processes the marketing data with reference to the commodity data, and provides the statistical data statistically processed to a manufacturer who produces the commodity.

(15) The information processing method according to any one of (12) to (14), in which

the information processing apparatus further statistically processes the marketing data with reference to store data regarding a store that sells the commodity, and provides the statistical data statistically processed to the store that sells the commodity or a distribution destination that distributes the commodity.

(16) A program causing an information processing apparatus to execute the steps of:

generating, on the basis of video data in which a purchasing behavior of a customer is imaged, customer action data regarding the purchasing behavior; and

generating marketing data on the basis of the customer action data.

(17) The program according to (16), which causes the information processing apparatus to execute the steps of:

generating the customer action data on the basis of the video data; and

generating the marketing data on the basis of the customer action data and commodity data regarding a commodity.

(18) The program according to (17), which causes the information processing apparatus to execute the steps of:

generating the customer action data and customer data regarding the customer on the basis of the video data; and

generating the marketing data on the basis of the customer data, the customer action data, the commodity data, and sales method data for selling the commodity.

(19) The program according to (17) or (18), which causes the information processing apparatus to further execute the steps of:

statistically processing the marketing data with reference to the commodity data; and

providing the statistical data statistically processed to a manufacturer who produces the commodity.

(20) The program according to any one of (17) to (19), which causes the information processing apparatus to further execute the steps of:

statistically processing the marketing data with reference to store data regarding a store that sells the commodity; and

providing the statistical data statistically processed to the store that sells the commodity or a distribution destination that distributes the commodity.

### REFERENCE SIGNS LIST

1 information processing system
10 imaging unit
20 terminal device
30, 100 information processing apparatus
40, 50 server device
220, 410, 510 controller

1. An information processing apparatus, comprising
a controller that
generates, on a basis of video data in which a purchasing behavior of a customer is imaged, customer action data regarding the purchasing behavior, and
generates marketing data on a basis of the customer action data.

2. The information processing apparatus according to claim 1, wherein
the controller generates the marketing data on a basis of the customer action data and commodity data regarding a commodity.

3. The information processing apparatus according to claim 2, wherein
the controller
generates the customer action data and customer data regarding the customer on a basis of the video data, and
generates the marketing data on a basis of the customer data, the customer action data, the commodity data, and sales method data for selling the commodity.

4. The information processing apparatus according to claim 1, wherein
the controller generates the marketing data on a basis of sales data of a store that sells the commodity.

5. The information processing apparatus according to claim 4, wherein
the controller generates the marketing data on a basis of environment data including information regarding an event, a temperature, or weather in a vicinity of the store.

6. The information processing apparatus according to claim 2, further comprising
a server device that statistically processes the marketing data.

7. The information processing apparatus according to claim 6, wherein
the server device statistically processes the marketing data with reference to the commodity data.

8. The information processing apparatus according to claim 7, wherein
the server device provides statistical data to a manufacturer who produces the commodity, the statistical data being obtained by statistically processing the marketing data with reference to the commodity data.

9. The information processing apparatus according to claim 6, wherein
the server device stores store data regarding a store that sells the commodity, and statistically processes the marketing data with reference to the store data.

10. The information processing apparatus according to claim 9, wherein
the server device provides statistical data to the store that sells the commodity or a distribution destination that distributes the commodity, the statistical data being obtained by statistically processing the marketing data with reference to the store data.

11. An information processing method, comprising:
by an information processing apparatus,
generating, on a basis of video data in which a purchasing behavior of a customer is imaged, customer action data regarding the purchasing behavior; and
generating marketing data on a basis of the customer action data.

12. The information processing method according to claim 11, wherein
the customer action data is generated on a basis of the video data, and
the marketing data is generated on a basis of the customer action data and commodity data regarding a commodity.

13. The information processing method according to claim 12, wherein
the customer action data and customer data regarding the customer are generated on a basis of the video data, and
the marketing data is generated on a basis of the customer data, the customer action data, the commodity data, and sales method data for selling the commodity.

14. The information processing method according to claim 12, wherein
the information processing apparatus further statistically processes the marketing data with reference to the commodity data, and provides the statistical data statistically processed to a manufacturer who produces the commodity.

15. The information processing method according to claim 12, wherein
the information processing apparatus further statistically processes the marketing data with reference to store data regarding a store that sells the commodity, and provides the statistical data statistically processed to the store that sells the commodity or a distribution destination that distributes the commodity.

16. A program causing an information processing apparatus to execute the steps of:
generating, on a basis of video data in which a purchasing behavior of a customer is imaged, customer action data regarding the purchasing behavior; and
generating marketing data on a basis of the customer action data.

17. The program according to claim 16, which causes the information processing apparatus to execute the steps of:
generating the customer action data on a basis of the video data; and
generating the marketing data on a basis of the customer action data and commodity data regarding a commodity.

18. The program according to claim 17, which causes the information processing apparatus to execute the steps of:
generating the customer action data and customer data regarding the customer on a basis of the video data; and
generating the marketing data on a basis of the customer data, the customer action data, the commodity data, and sales method data for selling the commodity.

19. The program according to claim 17, which causes the information processing apparatus to further execute the steps of:
statistically processing the marketing data with reference to the commodity data; and
providing the statistical data statistically processed to a manufacturer who produces the commodity.

20. The program according to claim 17, which causes the information processing apparatus to further execute the steps of:
statistically processing the marketing data with reference to store data regarding a store that sells the commodity; and
providing the statistical data statistically processed to the store that sells the commodity or a distribution destination that distributes the commodity.
